(19) United States
(12) Patent Application Publication
(10) Pub. No.: US 2025/0028315 A1
(43) Pub. Date: Jan. 23, 2025

(54) REFRIGERATION UNIT SAFETY MONITORING AND ANOMALY ROOT CAUSE ANALYSIS

(71) Applicant: Axiom Cloud Inc., San Jose, CA (US)

(72) Inventors: Robert Leffler, Portland, ME (US); Nikhil Saralkar, Bala Cynwyd, PA (US); Michelle Jee Eun Kim, Charlottesville, VA (US)

(21) Appl. No.: 18/777,969

(22) Filed: Jul. 19, 2024

Related U.S. Application Data
(60) Provisional application No. 63/527,987, filed on Jul. 20, 2023.

(51) Int. Cl. G05B 23/02; G06N 3/088

(52) U.S. Cl. CPC G05B 23/0283; G06N 3/088; G05B 2223/02

(57) ABSTRACT

One variation of a method includes: aggregating language concepts, extracted from documents including refrigeration manuals for a set of refrigeration units, into a corpus of textual training data including descriptors of characteristics of refrigeration units and root causes of anomalous behaviors; training a language model on the corpus of textual training data to generate textual descriptions of root causes of anomalous behaviors; detecting an anomalous behavior occurring at a refrigeration unit; generating a textual descriptor of the anomalous behavior; generating a text string describing a root cause of the anomalous behavior based on proximity of characteristics of the refrigeration unit to characteristics of the set of refrigeration units and proximity of the textual descriptor to troubleshooting descriptions represented in the language model for a subset of analogous refrigeration units in the set of refrigeration units; generating a notification including the text string; and serving the notification to an operator.

### CROSS-REFERENCE TO RELATED APPLICATIONS

This Application claims the benefit of U.S. Provisional Application No. 63/527,987, filed on 20 Jul. 2023, which is incorporated in its entirety by this reference.

### TECHNICAL FIELD

This invention relates generally to the field of energy storage systems and more specifically to a new and useful method for safety monitoring and root cause analysis of refrigeration units.

### BRIEF DESCRIPTION OF THE FIGURES

FIG. 1 is a flowchart representation of a method;

FIG. 2 is a flowchart representation of the method;

FIG. 3 is a flowchart representation of the method; and

FIG. 4 is a flowchart representation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

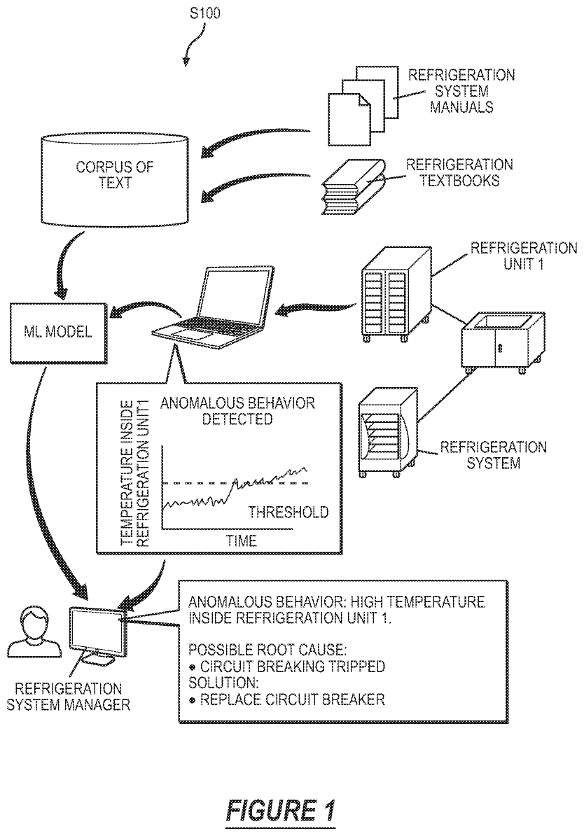

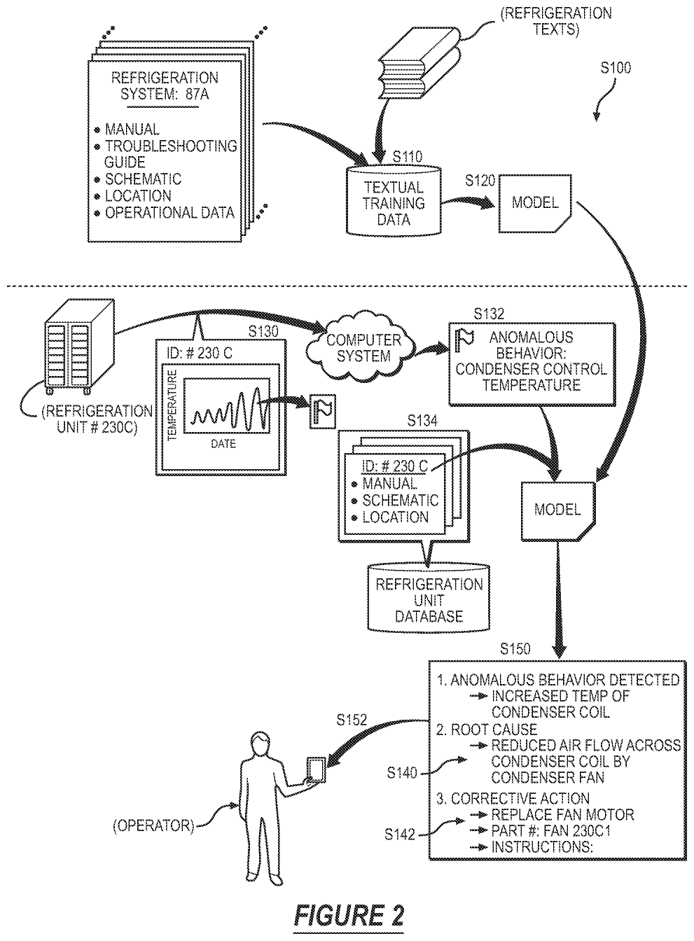

As shown in FIGS. 1-4, a method S100 includes, during an initial time period: extracting a set of language concepts from a set of documents including refrigeration manuals for a nominal set of refrigeration system types; aggregating the set of language concepts into a corpus of textual training data including descriptors of characteristics of the nominal set of refrigeration system types, anomalous behaviors occurring within refrigeration units of the nominal set of refrigeration system types, and root causes of anomalous behaviors occurring within refrigeration units of the nominal set of refrigeration system types in Block S110; and training a language model on the corpus of textual training data to generate textual descriptions of possible root causes of anomalous behaviors occurring within a global set of refrigeration system types including the nominal set of refrigeration system types in Block S120.

The method S100 further includes, during a first time period succeeding the initial time period, accessing a set of sensor data captured via a set of sensors coupled to a refrigeration unit in Block S130, and, in response to detecting a first anomalous behavior occurring at the refrigeration unit based on the set of sensor data: generating a first textual descriptor of the first anomalous behavior in Block S132; and accessing a set of characteristics of the refrigeration unit in Block S134. The method S100 further includes generating a first text string describing a first root cause of the first anomalous behavior based on: proximity of the set of characteristics to characteristics of the nominal set of refrigeration system types represented in the language model; and proximity of the first textual descriptor to troubleshooting descriptions represented in the language model for a subset of analogous refrigeration system types in the nominal set of refrigeration system types in Block S140.

The method S100 further includes: generating a notification including the first textual descriptor and the first text string in Block S150; and serving the notification to an operator associated with the refrigeration unit in Block S152.

A method S100 includes: extracting a set of language concepts from a set of documents, the set of documents including refrigeration manuals for a first set of refrigeration system types; aggregating the set of language concepts into a corpus of textual training data containing descriptors of characteristics of the first set of refrigeration system types, anomalous behaviors, and root causes of anomalous behaviors in Block S110; and training a language model (e.g., large language model) on the corpus of textual training data to generate textual descriptions of possible root causes of anomalous behaviors occurring within the first set of refrigeration units and within a second set of refrigeration units exhibiting characteristics similar to characteristics of a refrigeration unit within the first set of refrigeration units in Block S120.

The method S100 also includes: accessing a set of sensor data from sensors coupled to a refrigeration unit in Block S130; detecting an anomalous behavior occurring at the refrigeration unit based on the set of sensor data; generating a textual descriptor of the anomalous behavior in Block S132; and retrieving characteristics of the refrigeration unit in Block S134. The method S100 also includes: generating a text string describing a root cause of the anomalous behavior based on: proximity (e.g., textual proximity) of characteristics of the refrigeration unit to characteristics of refrigeration units, in the first set of refrigeration units (e.g., set of refrigeration units with manuals included in the corpus of training data), represented in the language model; and proximity (e.g., textual proximity) of textual descriptor for anomalous behavior to troubleshooting descriptions represented in the language model for a subset of analogous refrigeration units in the first set of refrigeration units in Block S140. The method S100 also includes: generating a notification containing the textual descriptor of the anomalous behavior and the text string describing the root cause of the anomalous behavior in Block S150; and serving the notification to an operator (e.g., a store manager, a building manager, a store associate, an in-store technician, a traveling technician or repair person, a refrigerator sales or support person) in Block S152.

### 1.1 Variation: Corrective Action

One variation of the method S100 includes, during an initial time period: extracting a set of language concepts from a set of documents including refrigeration manuals for a nominal set of refrigeration system types in Block S110; and aggregating the set of language concepts into a corpus of textual training data including descriptors of characteristics of the nominal set of refrigeration system types, anomalous behaviors occurring within refrigeration units of the nominal set of refrigeration system types, root causes of anomalous behaviors occurring within refrigeration units of the nominal set of refrigeration system types, and replacement parts for correcting root causes of anomalous behaviors at refrigeration units of the nominal set of refrigeration system types. The method S100 further includes, during the initial time period, training a language model on the corpus of textual training data to generate: textual descriptions of possible root causes of anomalous behaviors occurring within refrigeration units of a global set of refrigeration system types including the nominal set of refrigeration system types; and textual descriptions of replacement parts for correcting root causes of anomalous behaviors occurring within refrigeration units of the global set of refrigeration system types in Block S120.

In this variation, the method S100 further includes, during a first time period, accessing a set of sensor data captured via a set of sensors coupled to a refrigeration unit of a first refrigeration system type in Block S130, and, in response to detecting a first anomalous behavior occurring at the refrigeration unit based on the set of sensor data: generating a first textual descriptor of the first anomalous behavior in Block S132; and accessing a set of characteristics of the refrigeration unit in Block S134. The method S100 further includes: generating a first text string describing a root cause of the first anomalous behavior at the refrigeration unit based on proximity of the set of characteristics to characteristics of the nominal set of refrigeration system types represented in the language model and proximity of the first textual descriptor to troubleshooting descriptions represented in the language model for a subset of analogous refrigeration system types in the nominal set of refrigeration system types in Block S140; and generating a second text string describing a set of replacement parts for correcting the first anomalous behavior at the refrigeration unit based on proximity of the first textual descriptor to corrective action descriptions represented in the language model for the subset of analogous refrigeration system types in Block S142; generating a notification including the first textual descriptor, the first text string, and the second text string in Block S150; and serving the notification to an operator associated with the refrigeration unit in Block S152.

In one variation, the method S100 includes aggregating the set of language concepts into the corpus of textual training data further including descriptors of tools and procedures for correcting root causes of anomalous behaviors at refrigeration units of the nominal set of refrigeration system types. In this variation, Block S120 of the method S100 further includes training the language model on the corpus of textual training data to generate textual descriptions of tools and procedures for correcting root causes of anomalous behaviors occurring within refrigeration units of the global set of refrigeration system types. Furthermore, in this variation, Block S142 of the method S100 recites generating the second text string describing the first set of replacement parts, a first set of tools, and a sequence of steps of a first procedure for correcting the anomalous behavior.

In one variation, the method S100 includes: aggregating the set of language concepts into the corpus of textual training data that further contains descriptors of tools, replacement parts, and procedures for correcting root causes of anomalous behaviors at the first set of refrigeration units in Block S110; and training the language model on the corpus of textual training data to further generate textual descriptions of tools, replacement parts, and procedures for correcting root causes of anomalous behaviors at the first set of refrigeration units and at the second set of refrigeration units in Block S120.

In this variation, the method S100 also includes generating a second text string describing a set of tools, a set of replacement parts, and a sequence of steps of a procedure for correcting the anomalous behavior at the refrigeration unit based on: proximity of characteristics of the refrigeration unit to characteristics of refrigeration units, in the first set of refrigeration units, represented in the language model; and proximity of textual descriptors for anomalous behavior to corrective action descriptions represented in the language model for a subset of analogous refrigeration units in the first set of refrigeration units in Block S142. The method S100 includes: inserting the second text string describing the set of tools, the set of parts, and the sequence of steps of the procedure for correcting the anomalous behavior into the notification in Block S150; and serving the notification to the operator in Block S152.

In one variation, the method S100 can further include: automatically scheduling repair of the refrigeration unit by the refrigeration repair technician in Block S160; and serving the second text string to a refrigeration repair technician in preparation for repair of the refrigeration unit by the refrigeration repair technician in Block S162.

### 1.2 Variation: Text Embedding-Based Response Generation

One variation of the method S100 includes, during an initial time period: extracting a set of language concepts from a set of documents, the set of documents including documents related to refrigeration unit management, the set of language concepts including descriptions of characteristics of refrigeration units, anomalous behaviors of refrigeration units, and repair of refrigeration units in Block S110; aggregating the set of language concepts into a corpus of textual training data; representing the corpus of textual training data as a set of embeddings in an embedding space; and, based on the set of embeddings, training a language model to detect patterns of vocabulary, grammar, and semantics in the corpus of textual training data in Block S120. In this variation, the method S100 further includes, during an operating period for a refrigeration unit, accessing a set of sensor data representing operation of the refrigeration unit, and, in response to detecting an anomalous behavior occurring at the refrigeration unit based on the set of sensor data: generating a textual descriptor of the anomalous behavior in Block S132; accessing a set of characteristics of the refrigeration unit in Block S134; generating a query requesting identification of a root cause of the anomalous behavior in the refrigeration unit and including the textual descriptor and the set of characteristics; generating a first embedding corresponding to the query and representing semantic relationships of words in the query; identifying a first subset of embeddings, in the set of embeddings, proximal the first embedding within the embedding space; and extracting a subset of language concepts, in the set of language concepts, proximal the first subset of embeddings represented in the embedding space. The method S100 further includes: assembling the subset of language concepts into a first text string describing a first root cause of the anomalous behavior and a first corrective action for correcting the anomalous behavior at the refrigeration unit in Block S140 and Block S142; generating a notification including the first textual descriptor and the first text string in Block S150; and serving the first notification to a user associated with the refrigeration unit in Block S152.

Another variation of the method S100 includes: extracting a set of language concepts from a set of documents, the set of documents including documents related to refrigeration unit management (e.g., refrigeration unit manuals, refrigeration textbooks), the set of language concepts including descriptions of characteristics of refrigeration units, anomalous behaviors of refrigeration units, and repair of refrigeration units; aggregating the set of language concepts into a corpus of textual training data in Block S110; and training a language model on the corpus of textual training data to detect patterns (e.g., statistical relationships) of vocabulary (e.g., types of words), grammar (e.g., order of words), semantics (e.g., meaning of words) in the corpus of textual training data in Block S130.

The method S100 also includes: accessing sensor data representing operation of a refrigeration unit (e.g., deployed or operational within a grocery store) in Block S130; detecting an anomalous behavior occurring at the refrigeration unit based on the set of sensor data; generating a textual descriptor of the anomalous behavior in Block S132; retrieving characteristics of the refrigeration unit in Block S134; generating a text string describing a root cause of the anomalous behavior based on proximity of characteristics of the refrigeration unit to characteristics of refrigeration units, in the first set of refrigeration units, represented in the language model and proximity of textual descriptor for anomalous behavior to troubleshooting descriptions represented in the language model for a subset of analogous refrigeration units in the first set of refrigeration units in Block S140.

The method S100 also includes: in response to detecting the anomalous behavior, generating a query requesting identification of a root cause of the anomalous behavior in the refrigeration unit; generating a first embedding corresponding to the query, the first embedding representing semantic relationships of words in the query; based on the first embedding and a set of embeddings corresponding to the corpus of textual training data, extracting a set of language concepts near (e.g., proximal to) embeddings that are semantically similar to the query; aggregating the set of language concepts into the corpus of textual training data that further contains descriptors of tools, replacement parts, and procedures for correcting root causes of anomalous behaviors at the first set of refrigeration units; training the language model on the corpus of textual training data to further generate textual descriptions of tools, replacement parts, and procedures for correcting root causes of anomalous behaviors at the first set of refrigeration units and at the second set of refrigeration units; generating a text string describing a set of tools, a set of replacement parts, and a sequence of steps of a procedure for correcting the anomalous behavior at the refrigeration unit in Block S142. The method S100 also includes: generating a notification containing the text string describing a set of tools, a set of replacement parts, and a sequence of steps of a procedure for correcting the anomalous behavior in Block S150; and serving the notification to an operator in Block S152.

### 2. Applications

Generally, the computer system can transform sensor data from a refrigeration unit (e.g., a refrigerator or freezer installed in a grocery store) into textual descriptions of a) an anomalous behavior at the refrigeration unit, b) a predicted root cause of the anomalous behavior, and/or c) tools, replacement parts, and steps of a procedure for repairing the refrigeration unit. The computer system can then serve these textual descriptions to an operator (e.g., a store manager, a building manager, a store associate, a refrigerator sales or support person) or a repair technician (e.g., an in-store technician, a traveling technician, repair person).

Accordingly, the computer system can enable the operator to: remotely and preemptively gain awareness of anomalous behavior at the refrigeration unit; gain understanding of how to repair the refrigeration unit prior to (catastrophic) failure at the refrigeration unit, which may otherwise necessitate disposal of food in the refrigeration unit; and preemptively take action to repair the refrigeration unit.

Additionally, or alternatively, the computer system can enable the repair technician to: aggregate tools and replacement parts necessary to repair the refrigeration unit, such as prior to first inspecting the refrigeration unit, thereby avoiding redundant inspection and repair trips to the refrigeration unit and reducing time from first indication of the anomalous behavior at the refrigeration unit to repair of the refrigeration unit.

In particular, the computer system can: extract language concepts from a corpus of refrigeration unit manuals, troubleshooting guides, refrigeration unit specifications, and/or other textual and/or numerical data available for a set of makes and models of refrigeration units; and compile these language concepts into a language model that represents inter- and intra-make and model relationships between characteristics, nominal operating conditions, anomalous behaviors, root causes of anomalous behaviors and failures, corrective actions, and part replacement procedures for these refrigeration units.

The computer system can then: access sensor data from a refrigeration unit, such as time series temperature, pressure, vibration, and power consumption data from a set of sensors integrated into or attached to the refrigeration unit; interpret an anomalous behavior at the refrigeration unit; and generate or retrieve a language concept (or embedding) describing the anomalous behavior. Based on the language concepts describing the anomalous behavior and characteristics of the refrigeration unit, the computer system can: query the language model for language concepts describing a root cause of the anomalous behavior and tools, replacement parts, and/or steps of a procedure for repairing the refrigeration unit; assemble language concepts returned by the language model into a text string; and serve a prompt or notification—containing the text string—to an operator affiliated with the refrigeration unit and/or to a repair technician in preparation for servicing the refrigeration unit.

More specifically, different makes and models of refrigeration units may exhibit similar failures or anomalous behaviors and may require similar repairs or remediation. However, manuals, troubleshooting guides, and other support for an individual make and model of a particular refrigeration unit may be incomplete, such as missing repair guidance for common or uncommon failures. However, manuals, troubleshooting guides, and other repair support for other makes and models of refrigeration units may contain repair information relevant (e.g., adequate, accurate) to repairing the particular refrigeration unit.

Therefore, the computer system can execute the method S100 to: aggregate manuals, troubleshooting guides, and other repair support for a large population of makes and models of refrigeration units into a language model based on characteristic similarities between these makes and models; and autonomously draw from this aggregation of data stored in the language model to form a more complete manual, troubleshooting guide, and repair support for each individual make and model of refrigeration unit. Similarly, the computer system can execute the method S100 to: query the language model for root cause and corrective action descriptions for a new(er) make and model of refrigeration unit that is not otherwise represented in the language model (e.g., a refrigeration unit for which a manual, troubleshooting guide, and other supporting content was not available for training the language model); and return an output of the language model to the operator or repair technician.

More specifically, the computer system generates the language model representing root cause and corrective action (e.g., repair) concepts in association with characteristics of a large set of refrigeration unit makes and models by querying the language model for root cause and corrective action concepts based on an anomalous behavior and characteristics of a new refrigeration unit. Then, the language model can return root cause and corrective action concepts for similar refrigeration units, which may be sufficient or accurate to repair the new refrigeration unit despite lack of direct representation of the refrigeration unit in the language model.

### 2.1 Environmental Impact

In one implementation, the system described herein can execute the method S100 to detect leaks in industrial and commercial refrigeration systems including: a central refrigerant receiver; several (e.g., tens, dozens) refrigerated volumes; a compressor for each refrigerated volume (or group of refrigerated volumes); and hundreds or thousands of feet of piping connecting each compressor and refrigerated volume to the central refrigerant receiver. A leak may occur in any one of these components including along piping embedded within floors and walls. Therefore, detecting and finding the leak is a labor intensive and costly process. As a result, leaks in large refrigeration systems, such as those in grocery stores, go undetected for months at a time. Furthermore, commonly used refrigerants in these refrigeration systems (e.g., R-134A, R404A, R714, R717, R744, etc.) include hydrofluorocarbons (HFCs) and hydrofluoroolefins (HFOs) that are 10,000+ times more potent greenhouse gases than carbon dioxide or methane, thereby contributing significantly to the runaway greenhouse effect in Earth's atmosphere.

The computer system described herein is configured to execute the method S100 to detect anomalous behaviors—such as including refrigerant leaks—occurring at refrigeration units within days or weeks of incidence, thereby promoting decrease in amounts of refrigerant leaked into the environment and decreasing the environmental impact of refrigeration systems.

### 3. Sensors and Refrigeration Unit Networking

Generally, a refrigeration unit can include a set of sensors: installed or embedded in the refrigeration unit; and configured to output sensor data indicative of performance of the refrigeration unit. In one implementation, the computer system interfaces with the refrigeration unit (e.g., local controller of the refrigeration unit) and/or with a separate sensor module arranged on or in the refrigeration unit to collect sensor data representing statuses and operating characteristics of the refrigeration unit over time.

In one example, the refrigeration unit can include integrated sensors: embedded in the refrigeration unit; and configured to stream a sequence of readings to the local controller of the refrigeration unit. In another example, the refrigeration unit can include a discrete sensor module: including a set of sensors installed in the refrigeration unit; and configured to periodically receive sensor readings from the set of sensors. In one implementation, the local controller of the refrigeration unit or the sensor module can include a wired or wireless communication channel with a gateway, which passes sensor data to the computer system (e.g., remote computer system).

For example, the integrated sensors and/or the sensor module can include sensors such as: a temperature sensor configured to output readings representing temperature of the components of the refrigeration unit; a pressure sensor configured to output readings representing pressure inside sections of the refrigeration unit; a vibration sensor configured to output readings representing vibration level of the components of the refrigeration unit; a noise sensor configured to output readings representing a noise level of the refrigeration unit; and a power meter configured to output readings representing the power consumption of the components of the refrigeration unit.

### 4. Training the Language Model

Generally, the computer system can: extract a set of language concepts from a set of documents, the set of documents including refrigeration manuals for a first set of refrigeration system types; aggregate the set of language concepts into a corpus of textual training data containing descriptors of characteristics of the first set of refrigeration system types, anomalous behaviors, and root causes of anomalous behaviors; and train a language model (e.g., large language model) on the corpus of textual training data to generate textual descriptions of possible root causes of anomalous behaviors occurring within the first set of refrigeration units and within a second set of refrigeration units exhibiting characteristics similar to characteristics of a refrigeration unit within the first set of refrigeration units. Therefore, the computer system can train the language model on a corpus of textual training data to generate textual descriptions of possible root causes of anomalous behaviors occurring in a refrigeration unit associated with a manual that is not included in the corpus of textual training data. Additionally, the computer system can train the language model on a corpus of textual training data to generate textual descriptions of possible root causes of an anomalous behavior of a particular refrigeration unit, the anomalous behavior not described in a manual associated with the particular refrigeration unit.

For example, the computer system can: access a set of documents—such as including manuals, specifications, troubleshooting guides, etc.—corresponding to refrigeration units or a first set of refrigeration system types; extract a set of language concepts from the set of documents; aggregate the set of language concepts into a corpus of textual training data containing descriptors of characteristics of refrigeration units of the first set of refrigeration system types, anomalous behaviors exhibited by refrigeration units of the first set of refrigeration system types, and root causes of these anomalous behaviors; and train a language model on the corpus of textual training data to generate textual descriptions of possible root causes of anomalous behaviors occurring within refrigeration units of the first set of refrigeration system types and within refrigeration units of a second set of refrigeration system types.

In particular, in this example, the computer system can: access a first set of documents—including a first manual, a first troubleshooting guide, and/or a first set of recorded operating data representing anomalous behaviors, root causes of anomalous behaviors, and/or corrective actions for these root causes—corresponding to a first refrigeration unit of a first refrigeration system type (e.g., a first make and model of refrigeration unit); access a second set of documents—including a second manual, a second troubleshooting guide, and/or a second set of recorded operating data representing anomalous behaviors, root causes of anomalous behaviors, and/or corrective actions for these root causes—corresponding to a second refrigeration unit of a second refrigeration system type (e.g., a second make and model of refrigeration unit); access a third set of documents—including a third manual, a third troubleshooting guide, and/or a third set of recorded operating data representing anomalous behaviors, root causes of anomalous behaviors, and/or corrective actions for these root causes—corresponding to a third refrigeration unit of a third refrigeration system type (e.g., a third make and model of refrigeration unit); etc.

The computer system can then: compile this corpus of documents, such as including the first set of documents, the second set of documents, the third set of documents, etc.; extract a set of language concepts from this corpus of documents and aggregate the set of language concepts into a corpus of textual training data containing descriptors of characteristics of the first set of refrigeration system types, anomalous behaviors, and root causes of anomalous behaviors; and train a language model on the corpus of textual training data to generate textual descriptions of possible root causes of anomalous behaviors occurring within refrigeration units of the first refrigeration system type, the second refrigeration system type, the third refrigeration system type, etc. Furthermore, the computer system can train the language model to generate textual description of possible root causes of anomalous behaviors occurring within refrigeration units of a new refrigeration system type—not represented in the set of textual training data—based on similarities between the new refrigeration system type and refrigeration system types represented in the set of textual training data.

Additionally, in one implementation, the computer system can: aggregate the set of language concepts into the corpus of textual training data that includes descriptors of tools, replacement parts, and procedures for correcting root causes of anomalous behaviors at the first set of refrigeration units; and train the language model on the corpus of textual training data to generate textual descriptions of tools, replacement parts, and procedures for correcting root causes of anomalous behaviors at the first set of refrigeration units and at the second set of refrigeration units. Therefore, the computer system can train the language model on a corpus of textual training data to generate textual descriptions of tools, replacement parts, and procedures for correcting root causes of the anomalous behavior.

In one implementation, the computer system can: generate a corpus of textual training data containing documents related to refrigeration (e.g., refrigeration manuals, refrigeration textbooks); and train a language model (e.g., a large language model, a machine learning model) on the corpus of textual training data to learn patterns (e.g., statistical relationships) of vocabulary (e.g., types of words), grammar (e.g., order of words), semantics (e.g., meaning of words) in the corpus of textual training data. For example, the computer system can train the language model to predict masked words within a document, paragraph, and/or sentence in the corpus of textual training data. Therefore, the computer system can train a model to produce responses to queries about refrigeration based on the content of documents contained in the corpus of textual training data.

In one implementation, the computer system can train the language model (e.g., apply unsupervised learning) based on the corpus of textual training data by: segmenting the corpus of textual training data into a set of units of text, each unit of text in the set of units of text associated with a specific topic; and training the language model to predict masked words within each unit of text (e.g., documents, chapters, pages, paragraphs, sentences associated with a single topic) in the corpus of textual training data. Therefore, the computer system can train the language model to learn patterns, relationships, and linguistic structures in the units of text present in the corpus of textual training data and predict masked words in units of text based on these patterns, relationships, and linguistic structures.

### 4.1 Fine-Tuning the Language Model

In one implementation, the computer system can train a model on the corpus of textual training data by: compiling a set of sample anomalous behaviors and corresponding target root causes (e.g., a set of known anomalous behaviors and observed corresponding root causes); executing the language model to predict a root cause for each anomalous behavior in the set of sample anomalous behaviors; and, in response to the predicted root cause not matching the target root cause, modifying parameters of the language model to accommodate the specific task requirements to reduce prediction error. Therefore, the computer system can fine-tune the language model to accurately predict known root causes of known anomalous behaviors, thereby improving the performance and accuracy of the language model.

For example, the computer system can: access a set of observed anomalous behaviors exhibited by refrigeration units of a set of nominal refrigeration system types; and access a set of known root causes corresponding to the set of observed anomalous behaviors, each known target root cause, in the set of known root causes, corresponding to a particular observed anomalous behavior in the set of observed anomalous behaviors. Then, for a first observed anomalous behavior, in the set of observed anomalous behaviors, the computer system can: execute the language model to predict a first root cause, in a set of predicted root causes, of the first observed anomalous behavior; characterize a difference between the first root cause and a known root cause, in the set of known root causes, corresponding to the first observed anomalous behavior; and, in response to the difference exceeding a threshold difference, modify parameters of the language model accordingly to reduce prediction error. The computer system can thus repeat this process for each observed anomalous behavior, in the set of observed anomalous behaviors, to modify parameters of the language model accordingly and thus reduce prediction error.

### 5. Anomalous Behavior Detection

Generally, the computer system can: access a set of sensor data from sensors coupled to a refrigeration unit in Block S130; detect an anomalous behavior occurring at the refrigeration unit based on the set of sensor data; generate a textual descriptor of the anomalous behavior; and retrieve characteristics of the refrigeration unit in Block S132. Therefore, the computer system can detect anomalous behavior occurring at the refrigeration unit and generate a textual description of the anomalous behavior and the refrigeration unit, the characterization suitable for ingestion and processing by the language model.

In one implementation, the computer system can: access a sequence of readings output by a first sensor in the set of sensors, the sequence of readings transmitted by the wireless gateway to the external controller or streamed to the local controller by the set of sensors. The computer system can then, in response to a subset of readings in the sequence of readings exceeding or falling below threshold: detect anomalous behavior of the refrigeration unit in the sequence of readings; and generate a characteristic characterizing the anomalous behavior. In one implementation, the characteristic can include a text (e.g., a string value) description of the anomalous behavior. In one implementation, the characteristic can also include a numerical quantification of the anomalous behavior. For example, the characteristic can indicate that the subset of readings exceeded the threshold by X units.

In one implementation, the computer system can: access a sequence of readings output by a first sensor in the set of sensors; detect outlier readings in the sequence of readings using statistical methods or clustering methods (e.g., using k-means clustering, standard-deviations); based on the presence of outlier readings in the sequence of readings, detect anomalous behavior of the refrigeration unit; and generate the characteristic characterizing the anomalous behavior. For example, the computer system can: access a timeseries of temperature data captured by a set of temperature sensors coupled to the refrigeration unit; identify a series of outlier temperatures in the timeseries of temperature data; in response to identifying the series of outlier temperatures in the timeseries of temperature data, detect the first anomalous behavior at the refrigeration unit; and, in response to detecting the first anomalous behavior, generate the first textual descriptor indicating the series of outlier temperatures. In particular, in one example, the computer system can: identify a subset of outlier readings in the sequence of temperature readings output by a temperature sensor by computing a distribution (e.g., histogram) of values in the sequence of temperature readings; and detect a presence of outliers in the sequence of temperature readings in response to the distribution including readings three standard deviations below the mean.

In another example, the computer system can: access a timeseries of pressure data captured by a set of pressure sensors coupled to the refrigeration unit; based on the timeseries of pressure data, detect an anomalous behavior corresponding to a first decrease in pressure at a compressor discharge of the refrigeration unit and a second decrease in pressure at a compressor suction of the refrigeration unit; and, in response to detecting the first anomalous behavior, generate a textual descriptor indicating the first decrease in pressure at the compressor discharge and the second decrease in pressure at the compressor suction.

In one implementation, the computer system can: access a vector of readings (e.g., multiple sequences of readings) output by the set of sensors; input the vector of readings into a second model trained (e.g., on labeled data) to detect anomalous behavior of the refrigeration unit based on readings output by the subset of sensors; and execute the second model (e.g., machine learning model) to detect anomalous behavior and generate characteristics of the anomalous behavior. For example, the machine learning model can: identify a first pattern in the vector of readings, the first pattern including a decrease in pressure at the compressor discharge and simultaneous decrease in pressure at the compressor suction; and, in response to identifying the first pattern in the vector of readings, identify a possible refrigerant leak.

### 5.1 Sensor Data+Refrigeration Unit Characteristics:

Block S134 recites accessing a first set of characteristics of the first refrigeration unit in response to detecting the anomalous behavior occurring at the refrigeration unit.

Generally, the computer system can interface with a sensor module located or installed within a particular refrigeration unit to sample sensor data captured by the sensor module. The computer system can leverage a unique identifier—linked to sensor data output by the sensor module—to identify the particular refrigeration unit and thus identify and/or access characteristics of this particular refrigeration unit.

For example, the computer system can intermittently (e.g., once per day, once every other day, once per week) sample sensor data—captured by a sensor module installed within a particular refrigeration unit installed at a particular location—including a first unique identifier associated with the particular refrigeration unit; access a database of all refrigeration units—each refrigeration unit associated with a unique identifier—specifying characteristics of these refrigeration units; and, based on the first unique identifier, access a set of characteristics associated with the particular refrigeration unit, such as including a refrigeration system type—defining a make, a model, and/or a manufacturer—of the particular refrigeration unit, an age and/or date of manufacturing, a location (e.g., geographic location, type of store), a store owner and/or corresponding contact information, a date of installation at the location, a duration of active refrigeration (e.g., a number of hours), etc.

The computer system can then leverage these characteristics to identify refrigeration units and/or refrigeration system types—represented in the corpus of textual training data—exhibiting similar characteristics to the particular refrigeration unit.

### 6. Response Generation

Block S140 recites: generating a first text string describing a first root cause of the first anomalous behavior.

Generally, the computer system can generate a response (i.e., a text string) describing an anomalous behavior detected at a particular refrigeration unit, a (predicted) root cause of the anomalous behavior at the particular refrigeration unit, and/or a corrective action—such as specifying a set of replacement parts for installation, a set of tools required to install the set of replacement parts, and/or a sequence of actions or steps for installing the set of replacement parts—for correcting or mitigating the root cause and/or detected anomalous behavior at the particular refrigeration unit, regardless of whether the particular refrigeration unit is represented in the language model.

### 6.1 Response Generation: Root Cause of Anomalous Behavior

In one implementation, Block S140 of the method S100 recites generating a first text string describing a first root cause of the first anomalous behavior based on: proximity of characteristics of the first refrigeration system type to characteristics of the first set of refrigeration system types represented in the language model; and proximity of the first textual descriptor to troubleshooting descriptions represented in the language model for a subset of analogous refrigeration system types in the first set of refrigeration system types.

Generally, the computer system can generate a text string describing a root cause of the anomalous behavior based on: proximity of characteristics of the refrigeration unit to characteristics of refrigeration units, in the first set of refrigeration units, represented in the language model; and proximity of the textual descriptor for anomalous behavior to troubleshooting descriptions represented in the language model for a subset of analogous refrigeration units in the first set of refrigeration units. Therefore, the computer system can utilize the language model to generate a text string describing a root cause of the anomalous behavior observed in the refrigeration unit based on proximity of characteristics of the refrigeration unit to characteristics of refrigeration units associated with manuals included in the corpus of training data and based on proximity of the textual descriptor for the anomalous behavior to troubleshooting descriptions in manuals included in the in the corpus of training data.

In addition, the computer system is configured to: generate a notification containing the textual descriptor of the anomalous behavior and the text string describing the root cause of the anomalous behavior; and serve the notification to an operator. Therefore, in response to detecting anomalous behavior of a refrigeration unit, the computer system can present a notification (e.g., a warning notification) to the operator of the refrigeration unit, the notification indicating the anomalous behavior and the possible root cause of the anomalous behavior.

### 6.1.1 Multiple Root Causes

In one implementation, the computer system can suggest multiple root causes for a particular anomalous behavior detected at the refrigeration unit. In particular, in this implementation, the computer system can leverage similarities between a particular refrigeration unit and multiple refrigeration units—in a corpus of refrigeration units represented in the language model—to suggest multiple possible root causes of an anomalous behavior at the refrigeration unit.

For example, the computer system can: access a set of sensor data captured via a set of sensors coupled to a particular refrigeration unit of a refrigeration system type; detect a first anomalous behavior occurring at the refrigeration unit based on the set of sensor data; and, in response to detecting the first anomalous behavior, generate a first textual descriptor of the first anomalous behavior and retrieve a set of characteristics of the particular refrigeration unit and/or refrigeration system type. Then, the computer system can generate a first text string describing a first root cause of the first anomalous behavior at the particular refrigeration unit based on: proximity of characteristics of the refrigeration unit to characteristics of a first refrigeration unit, in a set of refrigeration units, represented in the language model; and proximity of the first textual descriptor to troubleshooting descriptions represented in the language model for the first refrigeration unit. Furthermore, the computer system can generate a second text string describing a second root cause of the first anomalous behavior at the particular refrigeration unit based on: proximity of characteristics of the refrigeration unit to characteristics of a second refrigeration unit, in the set of refrigeration units, represented in the language model; and proximity of the first textual descriptor to troubleshooting descriptions represented in the language model for the second refrigeration unit. The computer system can then present both the first and second text string—describing the first and second possible root causes of the first anomalous behavior at the particular refrigeration unit—to an operator associated with the refrigeration unit for review.

Additionally, in this implementation, the computer system can rank a set of possible root causes of a detected anomalous behavior at a refrigeration unit and generate a text string specifying a ranked list of possible root causes of the detected anomalous behavior at the refrigeration unit accordingly.

For example, the computer system can: access a set of sensor data captured via a set of sensors coupled to a particular refrigeration unit; detect an anomalous behavior occurring at the particular refrigeration unit based on the set of sensor data; and, in response to detecting the anomalous behavior, generate a textual descriptor of the anomalous behavior and retrieve a set of characteristics of the particular refrigeration unit. Then, the computer system can generate a first text string describing a first possible root cause of the anomalous behavior at the particular refrigeration unit based on: proximity of characteristics of the refrigeration unit to characteristics of a first refrigeration unit, in a set of refrigeration units, represented in the language model; and proximity of the textual descriptor to troubleshooting descriptions represented in the language model for the first refrigeration unit. Furthermore, the computer system can: generate a second text string describing a second possible root cause of the anomalous behavior based on: proximity of characteristics of the refrigeration unit to characteristics of a second refrigeration unit, in the set of refrigeration units, represented in the language model; and proximity of the textual descriptor to troubleshooting descriptions represented in the language model for the second refrigeration unit. Finally, the computer system can: generate a third text string describing a third possible root cause of the anomalous behavior based on: proximity of characteristics of the refrigeration unit to characteristics of a third refrigeration unit, in the set of refrigeration units, represented in the language model; and proximity of the textual descriptor to troubleshooting descriptions represented in the language model for the third refrigeration unit. The computer system can then: assign a rank to each of the first, second, and third possible root causes based on proximity of characteristics of the refrigeration unit to characteristics of the corresponding refrigeration unit represented in the language model and proximity of the textual descriptor to troubleshooting descriptions represented in the language model for the corresponding refrigeration unit; and compile the first, second, and third text strings—arranged according to rank—into a text string describing a ranked list of possible root causes of the anomalous behavior at the refrigeration unit.

In one example, the computer system can: predict a confidence score for a particular root cause of a detected anomalous behavior at a refrigeration unit; and rank the particular root cause, in a set of root causes, based on the confidence score.

In particular, in this example, the computer system can: detect an anomalous behavior occurring at a particular refrigeration unit based on a set of sensor data captured via a set of sensors coupled to the particular refrigeration unit; and, in response to detecting the anomalous behavior, generate a textual descriptor of the anomalous behavior and retrieve a set of characteristics of the particular refrigeration unit. The computer system can then: calculate a first confidence score for a first root cause, in a set of root causes, based on proximity of the textual descriptor to troubleshooting descriptions represented in the language model for a first refrigeration unit in a subset of analogous refrigerator units represented in the language model; and calculate a second confidence score for a second root cause, in the set of root causes, based on proximity of the textual descriptor to troubleshooting descriptions represented in the language model for a second refrigeration unit in the subset of analogous refrigerator units represented in the language model.

Then, in response to the first confidence score exceeding the second confidence score, the computer system can: generate a first text string describing the first root cause linked to the first confidence score; generate a second text string describing the second root cause linked to the second confidence score; populate a notification with the first text string and the first confidence score in a first slot corresponding to a first rank; populate the notification with the second text string and the second confidence score—less than the first confidence score—in a second slot (e.g., below the first slot, following the first slot) corresponding to a second rank less than the first rank; and serve the notification to an operator associated with the refrigeration unit.

Additionally or alternatively, in another implementation, the computer system can rank a set of possible root causes—derived for a particular anomalous behavior detected at a refrigeration unit—based on urgency of each root cause in the set of possible root causes. By ranking possible root causes according to urgency, the computer system can promote avoidance of catastrophic failure associated with the anomalous behavior.

### 6.1.2 Multiple Possible Root Causes: Diagnosis Steps

In one variation, the computer system can suggest implementation of a diagnostic procedure—such as defining a sequence of diagnostic steps or actions—for further investigating and/or confirming a predicted root cause of an anomalous behavior occurring at a refrigeration unit.

In one implementation, the computer system can suggest a diagnostic procedure configured to promote identification and/or confirmation of a particular root cause of an anomalous behavior, such as over one or more other possible root causes suggested for the anomalous behavior. For example, the computer system can: generate a first text string describing a first possible root cause of an anomalous behavior occurring at a refrigeration unit; generate a second text string describing a second possible root cause of the anomalous behavior occurring at the refrigeration unit; and generate a third text string including a prompt to further investigate the anomalous behavior—such as via execution of a sequence of diagnostic steps—to verify between the first root cause and the second root cause.

Additionally or alternatively, in another implementation, the computer system can suggest a diagnostic procedure—configured to promote identification and/or confirmation of a particular root cause of an anomalous behavior—in response to a confidence score predicted for the particular root cause falling below an upper threshold score and exceeding a lower threshold score.

For example, the computer system can: detect an anomalous behavior occurring at a particular refrigeration unit based on a set of sensor data captured via a set of sensors coupled to the particular refrigeration unit; and, in response to detecting the anomalous behavior, generate a textual descriptor of the anomalous behavior and retrieve a set of characteristics of the particular refrigeration unit. The computer system can then: predict a confidence score for a first root cause based on proximity of characteristics of the particular refrigeration unit to characteristics of the refrigeration units represented in the language model and proximity of the textual descriptor to troubleshooting descriptions represented in the language model for a subset of analogous refrigerator units represented in the language model; and, in response to the confidence score falling below a first threshold score and exceeding a lower threshold score, generate a text string describing a sequence of diagnostic steps for investigating occurrence of the first root cause at the refrigeration unit. The computer system can thus prompt an operator to execute the sequence of diagnostic steps accordingly in order to increase confidence in the first root cause of the anomalous behavior occurring at the refrigeration unit.

### 6.2 Response Generation: Corrective Action

Block S142 of the method S100 recites: generating a second text string describing a first set of replacement parts for correcting the anomalous behavior at the first refrigeration unit based on proximity of the first textual descriptor to corrective action descriptions represented in the language model for the subset of analogous refrigeration system types.

In one implementation, the computer system can generate a second text string describing a corrective action—such as specifying a set of tools, a set of replacement parts, and/or a sequence of steps of a procedure—for correcting the anomalous behavior at the refrigeration system based on: proximity of characteristics of the refrigeration system to characteristics of refrigeration units, in the first set of refrigeration units, represented in the language model; and proximity of the textual descriptor for the anomalous behavior to corrective action descriptions represented in the language model for a subset of analogous refrigeration units in the first set of refrigeration units.

The computer system can then: insert the second text string describing the set of tools, the set of parts, and the sequence of steps of the procedure for correcting the anomalous behavior into the notification; and serve the notification to the operator. Therefore, in response to detecting anomalous behavior of a refrigeration unit, the computer system can present a notification (e.g., a warning notification) to the operator of the refrigeration unit, the notification describing a set of tools, a set of replacement parts, and a sequence of steps of a procedure for correcting the anomalous behavior.

In this implementation, the computer system can initially train the language model (e.g., during a training period) to generate textual descriptions of corrective actions—such as defining tools, replacement parts, and procedures for correcting root causes of anomalous behaviors occurring at refrigeration units—for repairing refrigeration units and then leverage the language model to output text strings describing corrective actions for detected anomalous behaviors occurring at refrigeration units.

For example, during a training period, the computer system can: extract a set of language concepts from a set of documents including refrigeration manuals and/or troubleshooting guides for a nominal set of refrigeration system types; and aggregate the set of language concepts into a corpus of textual training data that includes descriptors of characteristics of the nominal set of refrigeration system types, anomalous behaviors occurring within refrigeration units of the nominal set of refrigeration system types, root causes of anomalous behaviors occurring within refrigeration units of the nominal set of refrigeration system types, and corrective actions—specifying tools, replacement parts, and/or steps of procedures—for correcting root causes of anomalous behaviors at refrigeration units of the nominal set of refrigeration system types. The computer system can then train the language model on the corpus of textual training data to generate: textual descriptions of possible root causes of anomalous behaviors occurring within refrigeration units of the nominal set of refrigeration system types; and textual descriptions of replacement parts for correcting root causes of anomalous behaviors occurring within refrigeration units of the nominal set of refrigeration system types.

Later, during a first time period succeeding the training period, the computer system can: access sensor data captured via a set of sensors coupled to a refrigeration unit; detect an anomalous behavior occurring at the refrigeration unit based on the set of sensor data; generate a textual descriptor of the anomalous behavior; and access a set of characteristics of the refrigeration unit. The computer system can then: generate a first text string describing a root cause of the anomalous behavior at the refrigeration unit based on proximity of characteristics of the refrigeration unit to characteristics of the nominal set of refrigeration system types represented in the language model and proximity of the textual descriptor to troubleshooting descriptions represented in the language model for a subset of analogous refrigeration system types in the nominal set of refrigeration system types; and generate a second text string—describing a corrective action—specifying a set of tools, a set of replacement parts, and/or a sequence of steps of a procedure for correcting the anomalous behavior—for repairing the refrigeration unit based on proximity of the textual descriptor to corrective action descriptions represented in the language model for the subset of analogous refrigeration units. The computer system can thus pair the second text string—describing the corrective action—with the first text string to generate a notification describing the (possible) root cause of the anomalous behavior detected at the refrigeration unit and a corrective action, corresponding to the root cause, for repairing the refrigeration unit.

### 6.2.1 Corrective Action: Multiple Possible Actions

In one implementation, the computer system can output a list of possible corrective actions—each corrective action specifying a set of replacement parts, a sequence of steps of a procedure for installing the set of replacement parts, and/or a set of tools required for executing the procedure—for repairing the refrigeration unit responsive to detection of an anomalous behavior occurring at the refrigeration unit.

For example, the computer system can execute Blocks of the method S100 described above to: generate a first text string describing a root cause of an anomalous behavior occurring at a refrigeration unit; generate a second text string describing a first corrective action—specifying a first set of tools, a first set of replacement parts, and a first sequence of steps of a first procedure for correcting the anomalous behavior—for repairing the refrigeration unit; and generate a third text string describing a second corrective action—specifying a second set of tools, a second set of replacement parts, and a second sequence of steps of a second procedure for correcting the anomalous behavior—for repairing the refrigeration unit. The computer system can then compile the first text string, the second text string, and the third text string into a notification for serving to a user affiliated with the refrigeration unit.

In particular, in one example, the computer system can output a list of corrective actions ranked according to confidence in each corrective action included in the list of corrective actions.

For example, the computer system can implement the language model to identify a first refrigeration system type and a second refrigeration system type—in a set of nominal refrigeration system types represented in the language model—exhibiting similar characteristics (e.g., size, temperature range, refrigerant type, heating and/or cooling capacity, voltage, configuration, type of store) to the refrigeration unit; based on the textual descriptor for the anomalous behavior, identify a first corrective action—specifying a first set of tools, a first set of replacement parts, and a first sequence of steps of a first procedure for correcting the anomalous behavior—for repairing the refrigeration unit based on corresponding corrective actions defined for refrigeration units of the first refrigeration system type; and, based on the textual descriptor for the anomalous behavior, identify a second corrective action—specifying a second set of tools, a second set of replacement parts, and a second sequence of steps of a second procedure for correcting the anomalous behavior—for repairing the refrigeration unit based on corresponding corrective actions defined for refrigeration units of the second refrigeration system type.

In the preceding example, the computer system can then: calculate a first similarity score between the refrigeration unit and refrigeration units of the first refrigeration system type based on the set of characteristics of the refrigeration unit and characteristics of the first refrigeration system type; calculate a second similarity score between the refrigeration unit and refrigeration units of the second refrigeration system type based on the set of characteristics of the refrigeration unit and characteristics of the second refrigeration system type; and, in response to the first similarity score exceeding the second similarity score, assign a first rank to the first corrective action and a second rank—less than the first rank—to the second corrective action.

Additionally or alternatively, in another example, the computer system can: output a list of corrective actions; and, for each corrective action, in the list of corrective actions, provide a predicted outcome, in a set of predictive outcomes, associated with implementation of the corresponding corrective action.

For example, the computer system can: generate a first text string describing a root cause of an anomalous behavior occurring at a refrigeration unit; generate a second text string describing a first corrective action—specifying a first set of tools, a first set of replacement parts, and a first sequence of steps of a first procedure for correcting the anomalous behavior—for repairing the refrigeration unit; and generate a third text string describing a first predicted outcome—such as specifying an amount of time spent, a financial cost, and/or an repair outcome—associated with implementation of the first corrective action. The computer system can similarly: generate a fourth text string describing a second corrective action—specifying a second set of tools, a second set of replacement parts, and a second sequence of steps of a second procedure for correcting the anomalous behavior—for repairing the refrigeration unit; and generate a fifth text string describing a second predicted outcome associated with implementation of the second corrective action.

### 6.2.2 Example: Analogous Refrigeration Units+Corrective Actions

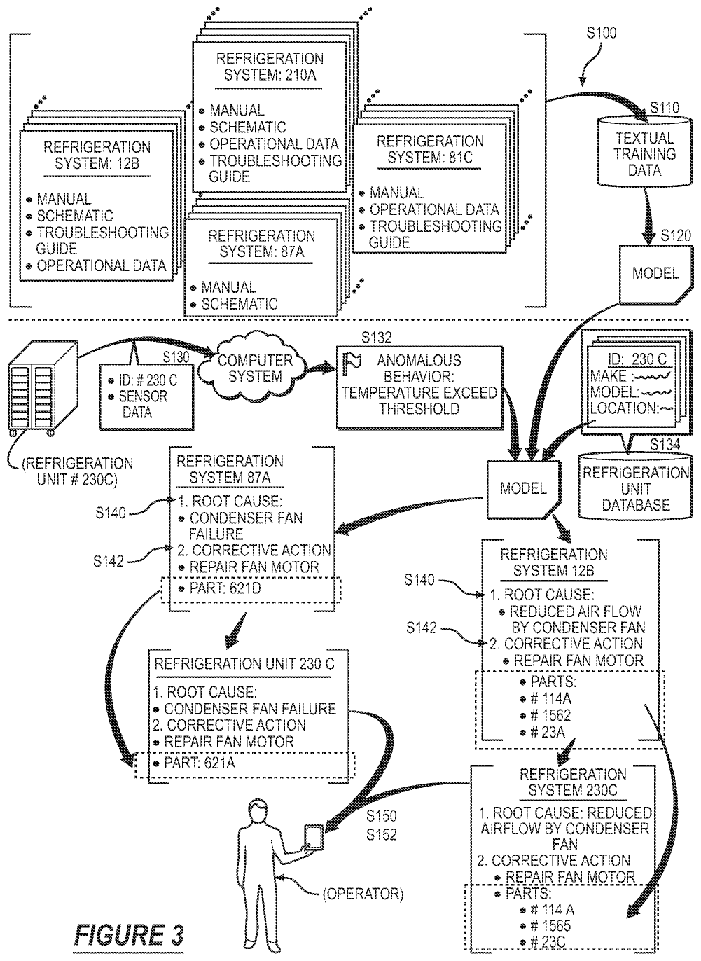

In one implementation, as shown in FIG. 3, the computer system can: retrieve a corrective action defined for correcting an anomalous behavior at a nominal refrigeration unit represented in the language model; and convert the corrective action—such as defining a set of replacement parts, a set of tools, and/or a procedure for correcting the anomalous behavior—to define an analogous corrective action corresponding to a target refrigeration unit not represented in the language model and currently exhibiting the anomalous behavior.

For example, the computer system can: access a set of sensor data captured via a set of sensors coupled to a target refrigeration unit; detect a target anomalous behavior occurring at the target refrigeration unit based on the set of sensor data; generate a textual descriptor of the target anomalous behavior; and retrieve a target set of characteristics of the target refrigeration unit.

Then, the computer system can leverage the language model—in combination with the textual descriptor of the target anomalous behavior and the target set of characteristics of the target refrigeration unit—to: identify a set of five refrigeration units—represented in the language model—exhibiting characteristics most similar to the target set of characteristics of the target refrigeration unit; and, for each refrigeration unit, in the set of five refrigeration units, extract a corrective action—such as defining a set of replacement parts, a set of tools, and/or a procedure for correcting anomalous behaviors analogous the target anomalous behavior—for correcting analogous anomalous behavior at the refrigeration unit. Then, for each refrigeration unit, in the set of five refrigeration units, the computer system can leverage the language model—in combination with known characteristics and/or any available literature (e.g., a refrigeration manual) for the target refrigeration unit—to convert the corrective action defined for the refrigeration unit, in the set of five refrigeration units, to a target corrective action applicable to the target refrigeration unit.

In particular, in one example, the computer system can leverage the language model—in combination with the textual descriptor of the target anomalous behavior and the target set of characteristics of the target refrigeration unit—to: identify a first refrigeration unit—represented in the language model—exhibiting characteristics similar to the target set of characteristics of the target refrigeration unit; extract a corrective action—defining a first set of replacement parts including a first compressor bearing defining a first part number specific to the first refrigeration unit—for anomalous behaviors (e.g., analogous the target anomalous behavior) at the first refrigeration unit; identify a second compressor bearing defining a second part number specific to the target refrigeration unit, such as via execution of an online search query and/or extraction from a knowledge graph representative of a set of refrigeration units—including the target refrigeration unit—in a particular store; and thus generate a text string describing a target corrective action—specifying a second set of replacement parts analogous the first set of replacement parts and including the second compressor bearing defining the second part number—for pairing with a first text string describing a root cause of the target anomalous behavior at the target refrigeration unit.

### 6.2.3 Variation: Refrigeration Unit Schematics

In one implementation, the computer system can leverage refrigeration unit schematics to identify a particular root cause—and/or a corresponding corrective action for the particular root cause—of an anomalous behavior occurring at a refrigeration unit.

For example, the computer system can: access a set of refrigeration schematics—including annotations and/or iconography—corresponding to a set of refrigeration units; access a set of manuals, troubleshooting guidelines, etc. for the set of refrigeration units; and represent each schematic, in the set of schematics, in a vector space, each schematic linked to a corresponding manual, troubleshooting guideline, etc. available for a refrigeration unit represented by the schematic. Then, the computer system can: access a set of sensor data captured via a set of sensors coupled to a target refrigeration unit (e.g., omitted from the set of refrigeration units represented in the vector space); detect a target anomalous behavior occurring at the target refrigeration unit based on the set of sensor data; generate a textual descriptor of the target anomalous behavior; retrieve a target schematic of the target refrigeration unit and/or a set of characteristics of the target refrigeration unit; represent the target refrigeration unit in the vector space based on the target schematic and/or the set of characteristics. The computer system can leverage the language model—in combination with the textual descriptor of the target anomalous behavior and the target set of characteristics of the target refrigeration unit—to: identify a group of schematics, in the set of schematics, proximal the target schematic within the vector space; and assemble a text string—describing a root cause of the anomalous behavior occurring at the target refrigeration unit—based on language concepts extracted from manuals, troubleshooting guidelines, etc. linked to refrigeration units, in the set of refrigeration units, represented by the group of schematics proximal the target schematic within the vector space. The computer system can similarly assemble a text string describing a corrective action—such as specifying a set of tools, a set of replacement parts, and/or a sequence of steps of a procedure—for correcting the anomalous behavior occurring at the target refrigeration unit.

### 6.3 Example: Unrepresented in Language Model

In one implementation, the computer system can execute Blocks of the method S100 described above to generate one or more text strings describing an anomalous behavior occurring at a refrigeration unit not represented in the language model, a root cause of the anomalous behavior, and/or a corrective action—defining a set of tools, a set of replacement parts, and/or a sequence of a steps of a procedure—for repairing the refrigeration unit.

For example, during a training period, the computer system can extract a set of language concepts from a set of documents including refrigeration manuals for a nominal set of refrigeration system types including: a first refrigeration system type defining a first set of characteristics—including a first size, a first set of refrigerator parts, and a first configuration of the first set of refrigerator parts—for refrigeration units of the first refrigeration system type; a second refrigeration system type defining a second set of characteristics—including a second size, a second set of refrigerator parts, and a second configuration of the second set of refrigerator parts—for refrigeration units of the second refrigeration system type; and a third refrigeration system type defining a third set of characteristics—including a third size, a third set of refrigerator parts, and a third configuration of the third set of refrigerator parts—for refrigeration units of the third refrigeration system type. The computer system can then: aggregate the set of language concepts into a corpus of textual training data including descriptors of characteristics of the nominal set of refrigeration system types, anomalous behaviors occurring within refrigeration units of the nominal set of refrigeration system types, and root causes of anomalous behaviors occurring within refrigeration units of the nominal set of refrigeration system types; and train a language model on the corpus of textual training data to generate textual descriptions of possible root causes of anomalous behaviors occurring within the nominal set of refrigeration system types.

During a first time period succeeding the training period, the computer system can then: access a set of sensor data captured via a set of sensors coupled to a refrigeration unit of a fourth refrigeration system type—omitted from the nominal set of refrigeration system types represented in the language model—defining a fourth set of characteristics including a fourth size, a fourth set of refrigerator parts, and a fourth configuration for the fourth set of refrigerator parts; and detect an anomalous behavior occurring at the refrigeration unit based on the set of sensor data.

In response to detecting the anomalous behavior occurring at the refrigeration unit, the computer system can then: generate a textual descriptor of the anomalous behavior; generate a first text string describing a first root cause of the anomalous behavior based on proximity of the fourth set of characteristics of the refrigeration unit to characteristics of the refrigeration system types in the nominal set of refrigeration system types represented in the language model and based on proximity of the textual descriptor to troubleshooting descriptions represented in the language model for a subset of analogous refrigeration system types in the nominal set of refrigeration system types.

8. Example: Template-Based Generation of a Response with References

In one implementation, in response to detecting anomalous behavior, the computer system can generate a query about the root cause of the anomalous behavior, the query including: characterization of anomalous behavior and a request to identify a root cause of the anomalous behavior. For example, the query may read, “what are the most likely root causes of low discharge pressure and low suction pressure in a supermarket refrigeration unit?” where the “low discharge pressure and low suction pressure” are characteristics of the anomalous behavior.

In one implementation, the computer system can select a subset of documents associated with the query by: generating an embedding in an embedding space for each word in the corpus of textual training data; generating a first vector in the embedding space, the first vector corresponding to the query; and generating a set of vectors corresponding to the set of documents in the corpus of textual training data. Additionally, or alternatively, the computer system can generate a set of vectors corresponding to pages, chapters, and/or sections of documents in the corpus of textual training data. The computer system can then, for each vector in the set of vectors: calculate a proximity between the first vector corresponding to the query and the vector; and, in response to the proximity score exceeding a threshold, identify a document corresponding to the vector as a document similar to the query. The computer system can then aggregate each document in the set of documents associated with the proximity exceeding a threshold into a subset of documents and provide the subset of documents as input to the language model prior to executing the language model to generate a response. Therefore, the computer system can: select a subset of documents from the set of documents, the subset of documents containing information relevant to the query; and then provide the documents in the subset of documents as citations as part of the response to a query.

In one implementation, the computer system can select a subset of documents associated with the query based on a type of refrigeration unit component (e.g., make, model, year made, type of the component) and/or a type of the refrigeration unit (e.g., make, model, type of refrigeration unit) exhibiting anomalous behavior. In particular, the computer system can identify a type of the refrigeration unit and/or the refrigeration unit component exhibiting the anomalous behavior based on metadata contained in the sequence of readings associated with the anomalous behavior. Then, the computer system can select a subset of documents relevant to the query and associated with the type of refrigeration unit (or refrigeration unit component) exhibiting anomalous behavior by: generating an embedding in an embedding space for each word in the corpus of textual training data; generating a first vector in the embedding space, the first vector corresponding to the query and the type of refrigeration unit (or refrigeration unit component); and generating a set of vectors corresponding to the set of documents in the corpus of textual training data. Additionally, or alternatively, the computer system can generate a set of vectors corresponding to pages, chapters, and/or sections of documents in the corpus of textual training data. The computer system can then, for each vector in the set of vectors: calculate a proximity between the first vector and the vector; and, in response to the proximity score exceeding a threshold, identify a document, in the subset of documents, corresponding to the vector. The computer system can then aggregate each document in the set of documents associated with the proximity exceeding a threshold into a subset of documents and provide the subset of documents as input to the language model prior to executing the language model to generate a response. Therefore, the computer system can: select a subset of documents from the set of documents, the subset of documents containing information relevant to the query and specific to the type of refrigeration unit (or refrigeration unit component) exhibiting the anomalous behavior; and then provide the documents in the subset of documents as citations as part of the response to a query.

In one implementation, the computer system can: select a template in a set of templates, generate a prompt by populating the template with: sample response summaries representing sample prompt answers by expert refrigeration technicians; the query; and a characterization of the anomalous behavior. Then, the computer system can: execute the language model to generate a response based on the prompt; and present the response to the refrigeration unit operator. Therefore, the computer system can generate a prompt served to the language model(e.g., large language model), the prompt specifying the anomalous behavior and instructing the language model to identify probable root causes of the anomalous behavior and to present a response in a particular format associated with the selected template. For example, the template may include instructions to act as an expert refrigeration technician and to provide summaries of the identified root causes of the anomalous behavior in a format similar to that of the sample summaries included in the template.

In one implementation, the computer system can select the template in the set of templates based on a profile of the refrigeration unit manager, type of the refrigeration unit, size of the refrigeration unit, location of the refrigeration unit, day of the week, time of the year, etc. For example, a first location of the first refrigeration unit may have a large number of expert refrigeration unit technicians while a second location of a second refrigeration unit may have a small number of expert refrigeration unit technicians. Thus, in the first location, the computer system can select a first template in the set of templates, the first template associated with a prompt that instructs the language model to provide a highly detailed description of the possible root cause of the anomalous behavior and to provide detailed steps for repairing the first refrigeration unit. Thus, a technician with less experience may use the response of the language model to repair the first refrigeration unit. However, in the second location, the computer system can select a second template in the set of templates, the second template associated with a prompt that instructs the language model to provide only a brief, high-level description of the possible root cause of the anomalous behavior. Therefore, the computer system can select the template in the set of templates that is tailored to specific preferences of a refrigeration unit manager.

In one implementation, the computer system can select a template in a set of templates, the template instructing the language model to identify a set of probable root causes of the anomalous behavior and for each probable root cause in the set of probable root causes: provide a description of the root cause of the anomalous behavior; provide a list of next diagnosis steps for confirming the root cause; provide a list of repair steps to repair the root cause of the anomalous behavior in the refrigeration unit; provide a list of tools associated with the repair steps; and provide a list of replacement components to repair the root cause of the anomalous behavior in the refrigeration unit. Therefore, the computer system can select a template that instructs the language model to identify probable root causes of the anomalous behavior and to provide instructions and components for repairing the refrigeration unit.

In one implementation, the computer system can select a template in a set of templates, the template instructing the language model to identify a set of probable root causes of the anomalous behavior, calculate the probability (e.g., likelihood) that each probable root cause in the set of probable root causes is a correct root cause; and provide an ordered list of probable root causes and the corresponding probabilities, the list ordered from highest probability to lowest probability.

In one implementation, the computer system can: execute the language model to generate a response based on the prompt and the subset of documents, the subset of documents containing documents relevant to the query; and present the response to the refrigeration unit operator, the response including citations corresponding to the documents in the subset of documents. Therefore, the computer system can generate a response including the probable root cause of the anomalous behavior, the repair steps for repairing the refrigeration unit, and relevant documents containing additional information from refrigeration textbooks or refrigeration manuals for addressing the root cause.

### 7. Operator Notification

Block S150 recites: generating a first notification including the first textual descriptor and the first text string in Block S150.

Generally, the computer system can compile the first textual descriptor describing the anomalous behavior occurring at the refrigeration unit and the first text string—describing a root cause of the anomalous behavior and/or a corrective action (e.g., defining a set of replacement parts, a set of tools, and/or a sequence of steps) for repairing the refrigeration unit—into a notification for serving to an operator affiliated with the refrigeration unit.

Furthermore, Block S152 recites: serving the first notification to a user associated with the refrigeration unit.

Generally, the computer system can serve a notification to a user—associated with a particular refrigeration unit and/or set of refrigeration units—indicating detection of an anomalous behavior at the particular refrigeration unit, indicating a root cause of the anomalous behavior, and/or including descriptors of tools, replacement parts, and/or procedures for correcting the root cause of the anomalous behavior.

In one implementation, the computer system can host or interface with an user portal (e.g., a native application or web application) executing on a computing device (e.g., a smartphone, a tablet, a desktop computer) accessed by the user (e.g., an operator or repair technician) to rapidly alert a user of detected anomalous behaviors at refrigeration units associated with the user—such as installed within a particular store—and provide the user with insights related to repair of these refrigeration units.

For example, the computer system can host or interface with an operator portal executing on a computing device accessed by an operator (e.g., a store manager, a building manager, a store associate, a refrigerator sales or support person) to alert the operator of a detected anomalous behavior occurring at a particular refrigeration unit and provide insights related to repair of the refrigeration unit prior to failure (e.g., catastrophic failure) of the refrigeration unit. Additionally or alternatively, in another example, the computer system can host or interface with a technician portal executing on a computing device accessed by a repair technician (e.g., an in-store technician, a traveling technician, repair person) to alert the operator of a detected anomalous behavior occurring at a particular refrigeration unit and provide detailed insights related to tools, replacement parts, and/or a sequence of steps of a procedure for repairing the refrigeration unit.

### 7.1 Variation: Batched Notifications

In one variation, the computer system can selectively group notifications—generated responsive to detection of anomalous behaviors occurring at one or more refrigeration units associated with a user (e.g., an operator, a technician)—for transmittal to the user (e.g., an operator, a technician) in a singular batch (e.g., at a singular timepoint) in order to minimize a quantity of individual notifications sent to the user over time.

In particular, in this variation, the computer system can: rapidly and/or immediately alert the user of a relatively high-risk anomalous behavior occurring at refrigeration unit affiliated with the user; and maintain a list of relatively low-risk anomalous behaviors—occurring at refrigeration units affiliated with the user over a particular time period (e.g., 24 hours, three days, one week, two weeks)—for transmitting to the user in a singular notification.

For example, in response to detecting a first anomalous behavior occurring at a refrigeration unit at a first time, the computer system can: implement the language model to generate a first text string describing a first root cause of the first anomalous behavior; predict a first risk score associated with the first anomalous behavior and/or the first root cause of the first anomalous behavior, such as based on predicted costs (e.g., time, labor, financial) associated with the first anomalous behavior and/or first root cause. Then, in response to the first risk score exceeding a threshold score, the computer system can: generate a first notification including a descriptor of the first anomalous behavior, the first text string describing the root cause, and/or a second text string describing one or more corrective actions for correcting the first anomalous behavior; and serve the first notification to the user associated with the refrigeration unit for immediate review by the user, such as within minutes, hours, or a day of detecting the first anomalous behavior.

Alternatively, in response to the first risk score falling below the threshold risk score, the computer system can: access an anomaly record including a list of anomalous behaviors occurring at refrigeration units affiliated with the user over a particular time period including the first time, corresponding root causes, and/or corresponding corrective actions for correcting these anomalous behaviors; and append the list of anomalous behaviors with the first anomalous behavior, the first text string describing the first root cause, and the second text string describing one or more corrective actions for correcting the first anomalous behavior. During the particular time period, the computer system can append the list of anomalous behaviors with additional anomalous behaviors—and corresponding root causes and/or corrective actions—detected at refrigeration units affiliated with the user and characterized by risk scores falling below the threshold risk score. Then, in response to expiration of the particular time period, the computer system can: generate a singular notification including the anomaly record generated for the particular time period; and transmit this singular notification to the user for review.

The computer system can therefore minimize notification fatigue experienced by the user by prioritizing transmittal of notifications associated with high-risk anomalous behaviors and/or root causes and grouping notifications—for transmittal to the user in a singular notification—associated with low-risk anomalous behaviors and/or root causes.

### 7.2 Automated Work Order Generation

In one variation, Block S60 of the method S100 recites automatically scheduling repair of the refrigeration unit by a technician (e.g., a refrigeration repair technician).

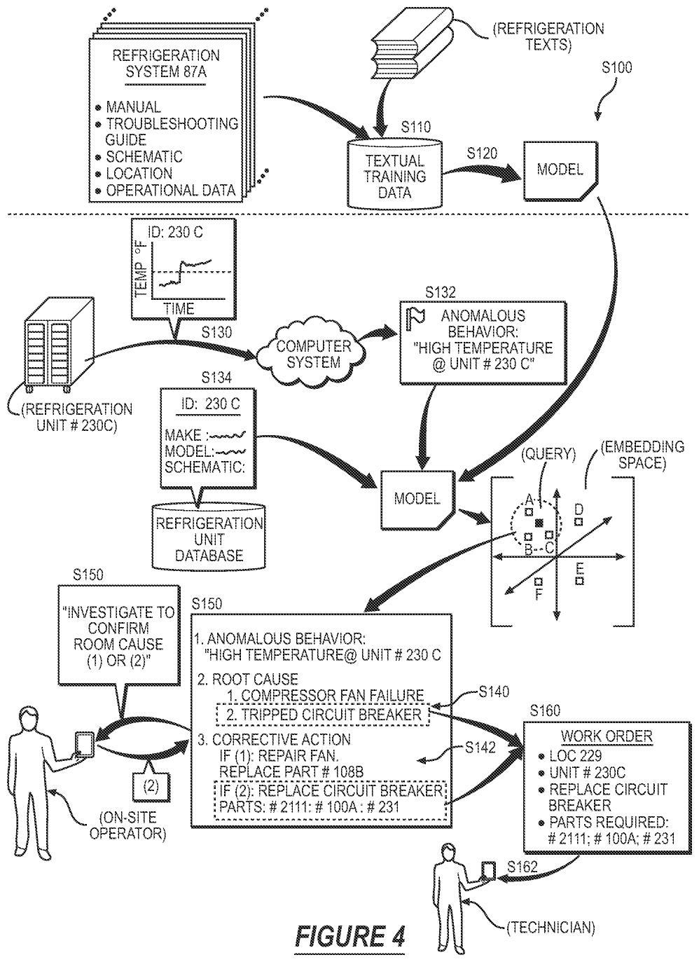

Generally, in this variation, as shown in FIG. 4, the computer system can: serve a second text string—describing a corrective action such as specifying a set of tools, a set of replacement parts, and/or a sequence of steps of a procedure for correcting the anomalous behavior at the refrigeration unit—to a technician (e.g., a refrigeration repair technician) in preparation for repair of the refrigeration unit by the refrigeration repair technician; and automatically schedule repair of the refrigeration unit by the refrigeration repair technician.

In particular, in response to detecting an anomalous behavior occurring at the refrigeration unit, the computer system can automatically generate a work order specifying a corrective action—such as defining a sequence of steps of a procedure for repairing the refrigeration unit, a set of replacement parts required to repair the refrigeration unit, and/or a set of tools required to execute the sequence of steps of the procedure—for repair of the refrigeration unit by a technician (e.g., an in-store technician, a traveling technician, a repair person) associated with the refrigeration unit. Additionally or alternatively, the computer system can populate the work order with a particular time window for executing the corrective action, such as within a particular duration of detection of the anomalous behavior and thus automatically schedule the work order for completion within this particular time window. The computer system can then serve this work order to the technician for execution by the technician accordingly.

In one implementation, the computer system can prompt an operator (e.g., a store manager, a building manager, a store associate, a refrigerator sales or support person) affiliated with the refrigeration unit to approve a work order for repairing a particular refrigeration unit prior to scheduling execution of the work order by a technician.

For example, in this implementation, the computer system can generate a notification including: a textual descriptor of an anomalous behavior occurring at the refrigeration unit; a first text string describing a root cause of the anomalous behavior; a second text string describing a corrective action—defining a set of tools, a set of replacement parts, and/or a procedure for correcting the root cause—for repair of the refrigeration unit; and a prompt to authorize a work order for correcting the anomalous behavior occurring at the refrigeration unit according to the corrective action. The computer system can then serve the notification to an operator affiliated with the refrigeration unit. Then, in response to receiving authorization of the work order, the computer system can: initialize the work order for the refrigeration unit; populate the work order with the second text string and/or a particular time window for completing the work order; and serve the work order to a technician for repair of the refrigeration unit according to the corrective action and/or the particular time window specified in the work order.

### 7.3 Variation: Confirmation of Root Cause

In one variation, the computer system can update the language model (e.g., via reinforcement learning) over time based on receipt of confirmation of a possible root cause of an anomalous behavior occurring at a refrigeration unit and suggested to a user (e.g., an operator, a technician) affiliated with the refrigeration unit. In particular, the computer system can: receive confirmation or rejection of the possible root cause of the anomalous behavior occurring at the refrigeration from by the user; label the possible root cause—suggested to the user for the anomalous behavior—accordingly to indicate confirmation or rejection of the possible root cause; and leverage the labelled possible root cause to update the language model and thus more accurately predict known root causes of anomalous behaviors, thereby improving the performance and accuracy of the language model.

For example, the computer system can: generate a notification indicating detection of an anomalous behavior at a particular refrigeration unit, indicating a root cause of the anomalous behavior, and/or including descriptors of tools, replacement parts, and/or procedures for correcting the root cause of the anomalous behavior; populate the notification with a prompt to confirm or reject the root cause (e.g., via further investigation or review); and serve the notification to a user associated with the particular refrigeration unit. Then, in response to receiving confirmation of the root cause from the user, the computer system can: label the root cause with a first value (e.g., “true” or “false”, a numerical value) indicating confirmation of the root cause; and update the language model—such as via reinforcement learning—based on the root cause labelled with the first value. Alternatively, in response to receiving rejection of the root cause from the user, the computer system can: label the root cause with a second value indicating rejection of the root cause; and update the language model based on the root cause labelled with the second value accordingly.

Additionally or alternatively, in another example, the computer system can automatically confirm a root cause of an anomalous behavior in response to the user authorizing a work order for correcting the anomalous behavior occurring at the refrigeration unit (e.g., according to a suggested corrective action). In this example, in response to receiving authorization of the work order, the computer system can: automatically confirm the root cause of the anomalous behavior associated with the work order; label the root cause with a value indicating confirmation of the root cause; and update the language model (e.g., via reinforcement learning) based on the root cause labelled with the value accordingly. The computer system can therefore leverage feedback from the user to improve performance and accuracy of the language model over time.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
during an initial time period:
extracting a set of language concepts from a set of documents comprising refrigeration manuals for a nominal set of refrigeration system types;
aggregating the set of language concepts into a corpus of textual training data comprising descriptors of:
characteristics of the nominal set of refrigeration system types;
anomalous behaviors occurring within refrigeration units of the nominal set of refrigeration system types; and
root causes of anomalous behaviors occurring within refrigeration units of the nominal set of refrigeration system types; and
training a language model on the corpus of textual training data to generate textual descriptions of possible root causes of anomalous behaviors occurring within a global set of refrigeration system types comprising the nominal set of refrigeration system types; and
during a first time period succeeding the initial time period:
accessing a set of sensor data captured via a set of sensors coupled to a refrigeration unit; and
in response to detecting a first anomalous behavior occurring at the refrigeration unit based on the set of sensor data:
generating a first textual descriptor of the first anomalous behavior;
accessing a set of characteristics of the refrigeration unit;
generating a first text string describing a first root cause of the first anomalous behavior based on:
proximity of the set of characteristics to characteristics of the nominal set of refrigeration system types represented in the language model; and
proximity of the first textual descriptor to troubleshooting descriptions represented in the language model for a subset of analogous refrigeration system types in the nominal set of refrigeration system types;
generating a notification comprising the first textual descriptor and the first text string; and
serving the notification to an operator associated with the refrigeration unit.

2. The method of claim 1:
wherein aggregating the set of language concepts into the corpus of textual training data comprises aggregating the set of language concepts into the corpus of textual training data further comprising descriptors of tools, replacement parts, and procedures for correcting root causes of anomalous behaviors at refrigeration units of the first set of refrigeration system types;
wherein training the model on the corpus of textual training data comprises training the model on the corpus of textual training data to further generate textual descriptions of tools, replacement parts, and procedures for correcting root causes of anomalous behaviors at the first set of refrigeration units and at the second set of refrigeration units;
further comprising generating a second text string describing a first set of tools, a first set of replacement parts, and a first sequence of steps of a first procedure for correcting the first anomalous behavior at the refrigeration unit based on proximity of the first textual descriptor for the first anomalous behavior to corrective action descriptions represented in the language model for the subset of analogous refrigeration units;
wherein generating the notification comprising the first textual descriptor and the first text string comprises generating the notification comprising the first textual descriptor, the first text string, and the second text string; and
serving the notification to the operator.

3. The method of claim 2:
wherein generating the second text string describing the first set of tools, the first set of replacement parts, and the first sequence of steps of the first procedure based on proximity of the first textual descriptor to corrective action descriptions represented in the language model for the subset of analogous refrigeration units comprises generating the second text string describing the first set of tools, the first set of replacement parts, and the first sequence of steps of the first procedure based on proximity of the first textual descriptor to a first corrective action description represented in the language model for a first refrigeration unit in the subset of analogous refrigeration units;
further comprising generating a third text string describing a second set of tools, a second set of replacement parts, and a second sequence of steps of a second procedure for correcting the first anomalous behavior at the refrigeration unit based on proximity of the first textual descriptor to a second corrective action description represented in the language model for a second refrigeration unit in the subset of analogous refrigeration units; and
wherein generating the notification comprises generating the notification comprising the first textual descriptor, the first text string, the second text string, and the third text string.

4. The method of claim 2:
wherein generating the notification comprising the first textual descriptor and the first text string comprises generating the notification comprising the first textual descriptor, the first text string, the second text string, and a prompt to authorize a work order for correcting the first anomalous behavior occurring at the refrigeration unit; and
further comprising, in response to receiving authorization of the work order:
initializing the work order for the refrigeration unit;
populating the work order with the second text string; and
serving the work order to a technician for repair of the first refrigeration unit according to the work order.

5. The method of claim 1, wherein generating the text string comprises:
generating a query requesting identification of the root cause of the anomalous behavior in the refrigeration unit;
generating a first embedding corresponding to the query and representing semantic relationships of words in the query;
based on the first embedding and a set of embeddings represented in the language model and corresponding to the corpus of textual training data, extracting a first set of language concepts proximal a subset of embeddings, in the set of embeddings, proximal the first embedding; and
generating the text string based on the first set of language concepts.

6. The method of claim 1, wherein training the language model further comprises:
accessing a set of observed anomalous behaviors exhibited by refrigeration units of the set of nominal refrigeration system types;
accessing a set of known root causes corresponding to the set of observed anomalous behaviors, each known target root cause, in the set of known root causes, corresponding to a particular observed anomalous behavior, in the set of observed anomalous behaviors; and
for each observed anomalous behavior in the set of observed anomalous behaviors:
executing the language model to predict a root cause, in a set of predicted root causes, of the observed anomalous behavior;
characterizing a difference between the root cause and a known root cause, in the set of known root causes, corresponding to the observed anomalous behavior; and
in response to the difference exceeding a threshold difference, modifying parameters of the language model to reduce prediction error.

7. The method of claim 1:
wherein accessing the set of sensor data capture via the set of sensors comprises accessing a timeseries of temperature data captured by a set of temperature sensors coupled to the refrigeration unit; and
wherein generating the first textual descriptor in response to detecting the first anomalous behavior based on the set of sensor data comprises:
identifying a series of outlier temperatures in the timeseries of temperature data;
in response to identifying the series of outlier temperatures in the timeseries of temperature data, detecting the first anomalous behavior at the refrigeration unit; and
in response to detecting the first anomalous behavior, generating the first textual descriptor indicating the series of outlier temperatures.

8. The method of claim 1:
wherein accessing the set of sensor data capture via the set of sensors comprises accessing a timeseries of pressure data captured by a set of pressure sensors coupled to the refrigeration unit; and
wherein generating the first textual descriptor in response to detecting the first anomalous behavior based on the set of sensor data comprises:
based on the timeseries of pressure data, detecting the first anomalous behavior corresponding to a first decrease in pressure at a compressor discharge of the refrigeration unit and a second decrease in pressure at a compressor suction of the refrigeration unit; and
in response to detecting the first anomalous behavior, generating the first textual descriptor indicating the first decrease in pressure at the compressor discharge and the second decrease in pressure at the compressor suction.

9. The method of claim 1:
further comprising:
generating a set of embeddings in an embedding space representing the set of documents; and
representing the set of language concepts in the embedding space; and
wherein generating the first text string based on proximity of the set of characteristics of the first refrigeration unit to characteristics of the nominal set of refrigeration system types and proximity of the first textual descriptor to troubleshooting descriptions represented in the language model for the subset of analogous refrigeration system types comprises:
generating a query requesting identification of the first root cause of the first anomalous behavior;
generating a first embedding in the embedding space corresponding to the query;
for each embedding in the set of embeddings:
calculating a distance between the first embedding and the embedding; and
in response to the distance falling below a threshold distance, inserting the embedding in a set of target embeddings;
extracting a first set of language concepts, in the set of language concepts, proximal the set of target embeddings in the embedding space; and
assembling the first set of language concepts into the first text string.

10. The method of claim 1:
wherein extracting the set of language concepts from the set of documents comprising refrigeration manuals for the nominal set of refrigeration system types comprises extracting the set of language concepts from the set of documents comprising refrigeration manuals for the nominal set of refrigeration system types comprising:
a first refrigeration system type defining a first set of characteristics for refrigeration units of the first refrigeration system type, the first set of characteristics comprising a first size and a first configuration for a set of refrigerator components; and
a second refrigeration system type defining a second set of characteristics for refrigeration units of the second refrigeration system type, the second set of characteristics comprising a second size and a second configuration for the set of refrigerator components; and
wherein accessing the set of sensor data captured via the set of sensors coupled to the refrigeration unit comprises accessing the set of sensor data captured via the set of sensors coupled to the refrigeration unit defining the set of characteristics comprising a third size and a third configuration for the set of refrigerator components.

11. The method of claim 1:
further comprising, generating a second text string describing a second root cause of the first anomalous behavior based on:
proximity of the set of characteristics to characteristics of the nominal set of refrigeration system types represented in the language model; and
proximity of the first textual descriptor to troubleshooting descriptions represented in the language model for the subset of analogous refrigeration system types in the nominal set of refrigeration system types; and
wherein generating the notification comprising the first textual descriptor and the first text string comprises:
generating the notification comprising the first textual descriptor, the first text string, and the second text string; and
populating the notification with a prompt to further investigate the first anomalous behavior to verify between the first root cause and the second root cause.

12. The method of claim 11, wherein generating the notification comprising the first textual descriptor, the first text string, the second text string, and the prompt comprises:
calculating a first confidence score for the first root cause based on proximity of the first textual descriptor to troubleshooting descriptions represented in the language model for the subset of analogous refrigeration system types in the first set of refrigeration system types;
calculating a second confidence score for the second root cause based on proximity of the first textual descriptor to troubleshooting descriptions represented in the language model for the subset of analogous refrigeration system types in the first set of refrigeration system types; and
in response to the first confidence score exceeding the second confidence score:
populating the notification with the first text string and the first confidence score in a first slot; and
populating the notification with the second text string and the second confidence score in a second slot succeeding the first slot.

13. The method of claim 1:
further comprising:
predicting a confidence score for the first root cause; and
in response to the confidence score falling below a first threshold score and exceeding a second threshold score, generating a second text string describing a sequence of diagnostic steps for investigating occurrence of the first root cause at the refrigeration unit; and
wherein generating the notification comprising the first textual descriptor and the first text string comprises generating the notification comprising the first textual descriptor, the first text string, the second text string, and a prompt to execute the sequence of diagnostic steps.

14. A method comprising:
during an initial time period:
extracting a set of language concepts from a set of documents comprising refrigeration manuals for a nominal set of refrigeration system types;
aggregating the set of language concepts into a corpus of textual training data comprising descriptors of:
characteristics of the nominal set of refrigeration system types;
anomalous behaviors occurring within refrigeration units of the nominal set of refrigeration system types;
root causes of anomalous behaviors occurring within refrigeration units of the nominal set of refrigeration system types; and
replacement parts for correcting root causes of anomalous behaviors at refrigeration units of the nominal set of refrigeration system types; and
training a language model on the corpus of textual training data to generate:
textual descriptions of possible root causes of anomalous behaviors occurring within refrigeration units of a global set of refrigeration system types comprising the nominal set of refrigeration system types; and
textual descriptions of replacement parts for correcting root causes of anomalous behaviors occurring within refrigeration units of the global set of refrigeration system types; and
during a first time period:
accessing a set of sensor data captured via a set of sensors coupled to a refrigeration unit; and
in response to detecting a first anomalous behavior occurring at the refrigeration unit based on the set of sensor data:
generating a first textual descriptor of the first anomalous behavior;
accessing a set of characteristics of the refrigeration unit;
generating a first text string describing a root cause of the first anomalous behavior based on:
proximity of the set of characteristics to characteristics of the nominal set of refrigeration system types represented in the language model; and
proximity of the first textual descriptor to troubleshooting descriptions represented in the language model for a subset of analogous refrigeration system types in the nominal set of refrigeration system types;
generating a second text string describing a set of replacement parts for correcting the first anomalous behavior at the refrigeration unit based on proximity of the first textual descriptor to corrective action descriptions represented in the language model for the subset of analogous refrigeration system types;
generating a notification comprising the first textual descriptor, the first text string, and the second text string; and
serving the first notification to an operator associated with the refrigeration unit.

15. The method of claim 14:
wherein aggregating the set of language concepts into the corpus of textual training data comprising descriptors of replacement parts for correcting root causes of anomalous behaviors at refrigeration units of the nominal set of refrigeration system types comprises aggregating the set of language concepts into the corpus of textual training data comprising descriptors of tools, replacement parts, and procedures for correcting root causes of anomalous behaviors at refrigeration units of the nominal set of refrigeration system types;
wherein training the language model on the corpus of textual training data to generate textual descriptions of replacement parts for correcting root causes of anomalous behaviors occurring within refrigeration units of the global set of refrigeration system types comprises training the language model on the corpus of textual training data to generate textual descriptions of tools, replacement parts, and procedures for correcting root causes of anomalous behaviors occurring within refrigeration units of the global set of refrigeration system types; and
wherein generating the second text string describing the first set of replacement parts for correcting the anomalous behavior comprises generating the second text string describing the first set of replacement parts, a first set of tools, and a sequence of steps of a first procedure for correcting the anomalous behavior.

16. The method of claim 14, further comprising:
serving the second text string to a refrigeration repair technician in preparation for repair of the refrigeration unit by the refrigeration repair technician; and
automatically scheduling repair of the refrigeration unit by the refrigeration repair technician.

17. The method of claim 14:
wherein generating the second text string describing the first set of replacement parts based on proximity of the first textual descriptor to corrective action descriptions represented in the language model for the subset of analogous refrigeration units comprises generating the second text string describing the first set of replacement parts based on proximity of the first textual descriptor to a first corrective action description represented in the language model for a first refrigeration unit in the subset of analogous refrigeration units;
further comprising generating a third text string describing a second set of replacement parts for correcting the first anomalous behavior at the refrigeration unit based on proximity of the first textual descriptor to a second corrective action description represented in the language model for a second refrigeration unit in the subset of analogous refrigeration units; and
wherein generating the notification comprises generating the notification comprising the first textual descriptor, the first text string, the second text string, and the third text string.

18. The method of claim 14:
wherein generating the first text string describing the root cause based on proximity of the first textual descriptor to troubleshooting descriptions represented in the language model for the subset of analogous refrigeration system types comprises generating the first text string describing the root cause based on proximity of the first textual descriptor to troubleshooting descriptions represented in the language model for a first refrigeration system type, in the nominal set of refrigeration system types, exhibiting characteristics proximal the set of characteristics; and
wherein generating the second text string describing the set of replacement parts for correcting the first anomalous behavior at the refrigeration unit further comprises:
extracting a first corrective action description describing a first set of replacement parts for correcting anomalous behaviors, analogous the first anomalous behavior, at refrigeration units of the first refrigeration system type;
converting the first set of replacement parts to the set of replacement parts for correcting the first anomalous behavior at the refrigeration unit based on the set of characteristics of the refrigeration unit; and
generating the second text string describing the set of replacement parts.

19. A method comprising:
during an initial time period:
extracting a set of language concepts from a set of documents describing refrigeration unit management, the set of language concepts comprising descriptions of characteristics of refrigeration units, anomalous behaviors of refrigeration units, and repair of refrigeration units;
aggregating the set of language concepts into a corpus of textual training data;
representing the corpus of textual training data as a set of embeddings in an embedding space; and
based on the set of embeddings, training a language model to detect patterns of vocabulary, grammar, and semantics in the corpus of textual training data; and
during an operating period for a refrigeration unit:
accessing a set of sensor data representing operation of the refrigeration unit; and
in response to detecting an anomalous behavior occurring at the refrigeration unit based on the set of sensor data;
generating a textual descriptor of the anomalous behavior;
retrieving a set of characteristics of the refrigeration unit;
generating a query requesting identification of a root cause of the anomalous behavior in the refrigeration unit and describing the set of characteristics;
generating a first embedding corresponding to the query and representing semantic relationships of words in the query;
identifying a first subset of embeddings, in the set of embeddings, proximal the first embedding within the embedding space;
extracting a subset of language concepts, in the set of language concepts, proximal the first subset of embeddings represented in the embedding space;
assembling the subset of language concepts into a first text string describing:
a first root cause of the anomalous behavior; and
a first corrective action for correcting the anomalous behavior at the refrigeration unit;
generating a first notification comprising the first textual descriptor and the first text string; and
serving the first notification to a user associated with the refrigeration unit.

20. The method of claim 19:
further comprising:
aggregating the set of language concepts into the corpus of textual training data that further contains descriptors of tools, replacement parts, and procedures for correcting root causes of anomalous behaviors at the first set of refrigeration units;
training the language model on the corpus of textual training data to further generate textual descriptions of tools, replacement parts, and procedures for correcting root causes of anomalous behaviors at the first set of refrigeration units and at the second set of refrigeration units; and
generating a second text string describing a set of tools, a set of replacement parts, and a sequence of steps of a procedure for correcting the anomalous behavior at the refrigeration unit; and
wherein generating the notification comprising the textual descriptor and the first text string comprises generating the notification comprising the textual descriptor the first text string, and the second text string.
